(19) United States
(12) Patent Application Publication
(10) Pub. No.: US 2006/0240923 A1
(43) Pub. Date: Oct. 26, 2006

(54) Timing transmission having enhanced timing chain removal and replacement feature, and method

(75) Inventor: Masanori Yokoyama, Osaka (JP)

Correspondence Address: HOWSON AND HOWSON, SUITE 210, 501 OFFICE CENTER DRIVE, FT WASHINGTON, PA, 19034, US

(73) Assignee: Tsubakimoto Chain Co., Osaka (JP)

(21) Appl. No.: 11/368,992

(22) Filed: Mar. 6, 2006

(30) Foreign Application Priority Data
Apr. 6, 2005 (JP) 2005-109787

(51) Int. Cl. F16H 7/08; F16H 7/18

(52) U.S. Cl. 474/111; 474/140

(57) ABSTRACT

In an internal combustion engine having a timing transmission, tension in the timing chain is released for removal of the chain by pushing a tensioner-urged movable guide away from the chain and holding the guide in a tension-releasing position by a fixing jig inserted through a hole in the timing chain cover while the timing chain cover is still connected to the engine block by partially loosened fasteners.

### CROSS-REFERENCE TO RELATED APPLICATIONS

This application claims priority on the basis of Japanese patent application 2005-109787, filed Apr. 6, 2005. The disclosure of Japanese application 2005-109787 is hereby incorporated by reference.

### FIELD OF THE INVENTION

The invention relates to improvements in the maintainability of the timing transmission of an internal combustion engine for a vehicle, and more particularly to a timing transmission having an enhanced timing chain removal and replacement feature, and to an improved method for timing chain removal and replacement.

### BACKGROUND OF THE INVENTION

In the timing drive of most vehicular internal combustion engines, an endless, flexible, traveling, transmission medium is used to transmit power from crankshaft sprocket to one or more camshaft sprockets. The transmission medium is typically a roller chain, silent chain, toothed belt, or the like.

For convenience, the invention will be described with reference to a timing transmission incorporating a chain. However, it should be understood that the invention is applicable to other timing drives in which an endless, flexible traveling transmission medium is utilized, and tension is maintained in the transmission medium by means of a movable sliding contact guide.

Typically, in an engine timing drive utilizing a chain, a fixed guide is disposed in sliding engagement with the tension side of the chain, that is, the side moving from a driven sprocket to the driving sprocket, and a movable guide is disposed in sliding engagement with the slack side of the chain, that is, the side moving from the driving sprocket to a driven sprocket. The guides control the path of the chain to prevent vibration, both in the plane of movement of the chain and in directions transverse the plane of movement of the chain. The movable guide also cooperates with a tensioner to maintain appropriate tension in the chain. The movable guide is typically pivoted on a mounting bolt or pin attached to, and protruding from, the engine block. The tensioner typically comprises a tensioner housing, and a sliding plunger protruding from the housing and in engagement with the movable guide. A biasing spring inside the tensioner housing urges the plunger in the protruding direction, thereby pressing the movable guide against the chain to maintain tension in the chain. A conventional transmission device of the kind described above is depicted in FIG. 5, and explained in detail in the U.S. Pat. 6,086,498, granted Jul. 11, 2000.

Frequently, the chain used the timing transmission needs to be replaced (or repaired) because of wear or excessive elongation. To remove the chain, the timing chain cover must be either loosened or removed from the engine. Then, tension applied to the chain through the movable guide must be relieved to produce enough slack in the chain to enable it to be disengaged from its sprockets. Since the plunger of the tensioner is usually held in the tensioner housing only by the opposing force of the chain, removal of the chain can allow the plunger to fall out of the tensioner housing. If the plunger falls out, and even if it is allowed to extend past its normal position, it must be manually reset. Resetting is difficult to accomplish, especially in the case of a ratchet-type tensioner, since it is not easy to gain access to the ratchet mechanism of the tensioner in order to release the pawl or pawls, and push the plunger back into the housing. In fact, in many cases, it is difficult to gain access to the movable guide.

Accordingly, in replacing a timing chain, at least two workers are often needed, one to apply pressure to the movable guide in order to relieve tension in the chain while the other disengages the chain from the crankshaft and camshaft sprockets. It is necessary to remove, or at least loosen, the timing chain cover in order to reach the movable guide, and in some cases, especially where there is little room in front of the engine, the timing chain cover cannot be removed, or loosened sufficiently, and the entire engine must be removed from the engine compartment of the vehicle.

The principal objects of this invention are to avoid the above-mentioned problems encountered in conventional methods of timing chain replacement, to provide a simpler method of chain removal, and to make chain removal more efficient. It is also an object of the invention to avoid the need for removal of a timing chain cover from the engine compartment, and to avoid the need for removal of the entire engine from the engine compartment.

### SUMMARY OF THE INVENTION

The timing transmission assembly in accordance with the invention comprises a crankshaft sprocket, one or more camshaft sprockets, and an endless, flexible, traveling transmission medium, preferably a chain such as a roller chain or a silent chain, arranged to travel in a plane of movement, and engaged with the sprockets for transmitting rotation from the crankshaft sprocket to the one or more camshaft sprockets. A movable guide, preferably a pivoted guide, is arranged to apply tension to a part of the transmission medium movable from the crankshaft sprocket toward a camshaft sprocket. The guide is movable toward and away from the transmission medium, and has an engagement surface facing the transmission medium. A tensioner, preferably a tensioner having a housing and a protruding plunger, urges the guide against the transmission medium in order to apply tension to the transmission medium.

The timing transmission is incorporated in an internal combustion engine in an enclosed compartment formed by cooperation of a timing transmission cover with the engine block. Fastening means for attaching the timing transmission cover to the engine block, are loosenable to allow the timing transmission cover to be separated from the engine block sufficiently to provide access the transmission medium, and preferably also to the guide, through a space between the engine block and the edge of the timing transmission cover. The timing transmission cover has a through hole positioned so that a fixing jig extending through the hole can engage the engagement surface of the guide when the guide is moved to a tension-releasing position in which the transmission medium is allowed to be removed from the sprockets. The fixing jig holds the guide in the tension-releasing position, and the transmission medium can be removed from the sprockets while the timing transmission cover is separated from the engine block by only a short distance, without the need for insertion of a tool between the edge of the cover and the engine block to hold the movable guide in the tension-releasing position.

The length of the fastening means is preferably sufficient to allow the timing transmission cover to be separated from the engine block to allow access to the movable guide and the transmission medium through a space between the edge of the cover and the engine block without the fastening means being disconnected from the engine block. Preferably, the fastening means includes at least two fasteners that, when loosened, allow the timing transmission cover to be separated from the engine block sufficiently to allow access to the guide and the transmission medium through a space between the engine block and the edge of the timing transmission cover, while substantially preventing lateral movement of the timing transmission cover, that is, movement in directions parallel to the plane of movement of the traveling transmission medium. The through hole in the timing transmission cover is preferably sufficiently long and narrow to hold the fixing jig in a fixed position when the fixing jig is engaged with the engagement surface of the movable guide, and the movable guide is in the tension-releasing position.

The invention allows a timing transmission medium to be removed by a novel method, in which the fastening means which connect the timing transmission cover to the engine block are loosened sufficiently to provide access, through a space between the engine block and an edge of the cover, to the chain and preferably also to the movable guide, but not enough to allow the timing chain cover to shift parallel to the plane of travel of the chain. The movable guide is pushed in a direction to allow slack in the chain, preferably by gaining access to the movable guide through the space between the engine block and the edge of the cover. Then a fixing jig is inserted through a hole in the timing transmission cover, and engaged with the movable guide while the guide is positioned to allow slack in the chain. The fixing jig, in cooperation with the cover, temporarily prevents movement of the guide toward the chain, while the chain is removed from the sprockets.

The invention greatly simplifies the removal and replacement of a timing chain or the like, since it enables the chain to be removed and replaced without complete removal of the timing chain cover, while the engine remains in place in the engine compartment of the vehicle. The use of a fixing jig, in cooperation with the timing chain cover, to hold the movable guide in a tension-releasing condition, makes it possible for a single individual to remove a timing chain. The fixing jig holds the guide in the tension-releasing condition until the chain can be replaced. Consequently, the plunger is prevented from dropping out of the tensioner housing, and the steps of reassembling the tensioner, and pushing the lever to its tension-releasing position during installation of a replacement chain, are avoided.

### BRIEF DESCRIPTION OF THE DRAWINGS

FIG. 1 is a schematic elevational view of the timing transmission of a dual overhead cam in an internal combustion engine equipped with a conventional fixed guide and a preferred embodiment of a movable sliding contact guide in accordance with the invention;

FIG. 2 is a side elevational view of the movable sliding contact guide;

FIG. 3 is cross-sectional view of the guide of FIG. 2, taken on section plane 3-3 in FIG. 2, shown in cooperation with a timing chain cover and a fixing jig;

FIG. 4 is a perspective view showing a timing chain cover partially separated from an engine block, and also showing a fixing jig; and

FIG. 5 is a sectional view of the timing chain case of an engine, showing, in elevational view, a conventional timing transmission.

### DETAILED DESCRIPTION OF THE PREFERRED EMBODIMENTS

The conventional timing transmission, as shown in FIG. 5, is disposed within a timing transmission case 21 formed as an integral part of the engine block, and enclosed by a timing transmission cover (not shown). A chain 25 is in mesh with a crankshaft sprocket 24 and two camshaft sprockets 23. A fixed guide 31 is in sliding engagement with the tension side of the chain, i.e., the portion of the chain that moves from one of the camshaft sprockets 23 toward the crankshaft sprocket 24. A movable guide 27 is in sliding engagement with the slack side of the chain, i.e., the portion of the chain that moves from the crankshaft sprocket 24 toward one of the camshaft sprockets 23. The movable guide is pivoted on a shaft 28, which is fixed to the engine block, and is urged toward the chain by the plunger 26a of a tensioner 26, the plunger protruding from a tensioner housing 26b. The guide is composed of a chain-engaging shoe 29 mounted on a supporting member 30, having reinforcing ribs 30a. The plunger engages a plunger-receiving part 27a of the support at a location remote from the pivot shaft 28.

As mentioned previously, in a conventional timing transmission, it is difficult to remove the chain without complete removal of the timing chain cover to allow access to the tensioner and the movable guide so that tension in the chain can be relieved. It is also difficult to hold the movable guide against the plunger to prevent the plunger from falling out of the tensioner while the chain is being replaced. In some cases, the engine must be removed from the engine compartment of the vehicle for chain replacement.

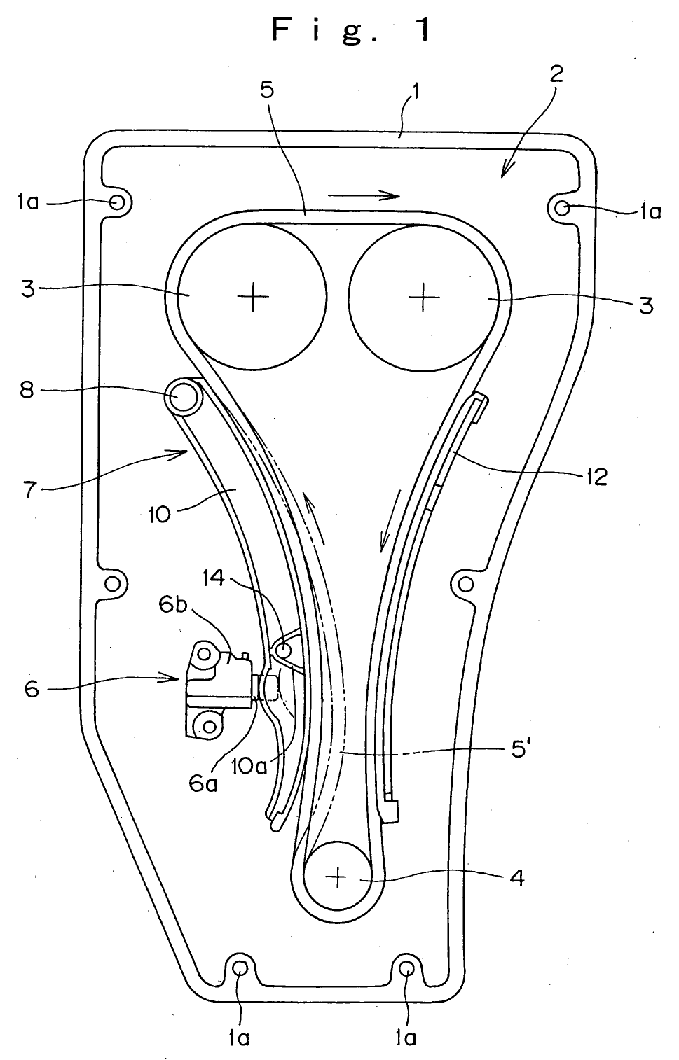

The timing transmission according to the invention is generally similar to the convention timing transmission of FIG. 5 in that it comprises a timing transmission case 1, in which a chain 5 is arranged to transmit power from a crankshaft sprocket 4 to a pair of camshaft sprockets 3, a fixed guide 12 in sliding engagement with the tension side of the chain, a pivoted, movable, guide 7 in sliding engagement with the slack side of the chain, and a tensioner 6 having a plunger 6a, protruding from a housing 6b, and urging the plunger against the slack side of the chain. In the transmission of FIG. 1, the pivot shaft 8 for the guide is located adjacent a camshaft sprocket. However, the pivot shaft 8 could be arranged near the crankshaft sprocket as in FIG. 5.

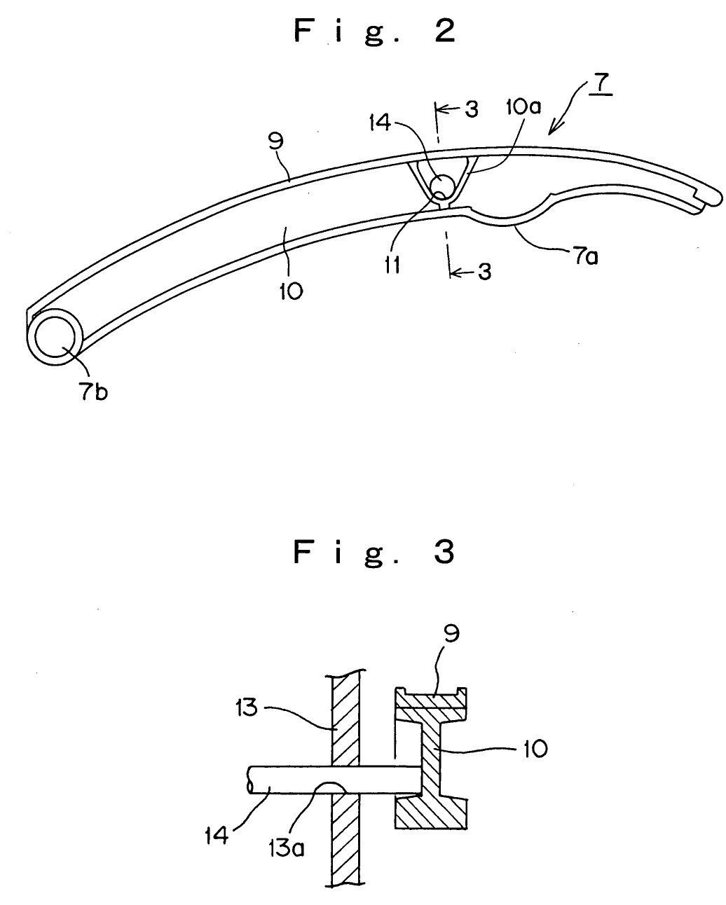

As shown in FIGS. 1 and 2, the movable guide 7 includes a shoe 9 having an outer surface for sliding contact with chain 5. The shoe 9, in this case is integrally molded with a support 10, which has a mounting hole 7b (FIG. 2) for receiving pivot shaft 8 (FIG. 1). A pad 7a on the support 10 is engageable by plunger 6a of the tensioner 6. A reinforcing rib 10a is formed on both sides of the support 10. Preferably, the entire guide structure is composed of an engineering plastic.

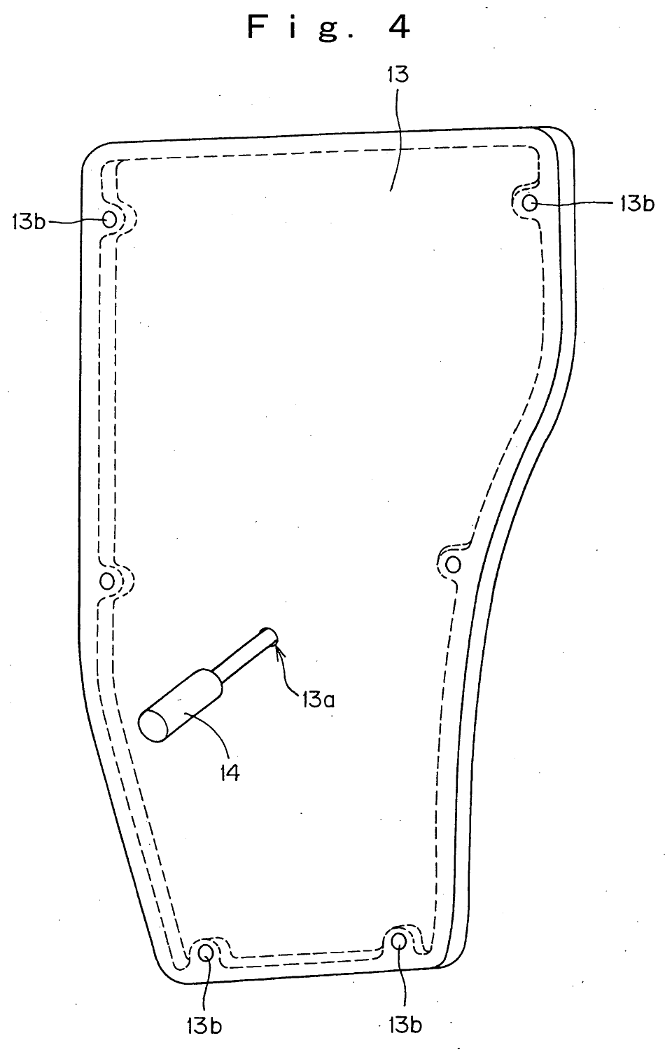

The reinforcing rib 10a is generally V-shaped, with a rounded bottom so that it presents a rounded, concave, engagement surface 11 (FIG. 2) facing toward the chain, as shown in FIG. 1. This engagement surface 11 is engageable with a fixing jig 14, which is preferably in the form of a round bar. The engagement surface 11 preferably has a slightly larger radius of curvature (for example 4.5 mm) than the radius of curvature of the fixing jig 14. The engagement surface 11 receives a front end of the fixing jig 14, as shown in FIG. 3, which, because of the V-shape of the reinforcing rib, can be easily inserted when the guide 7 is pivoted away from the chain, as shown in FIG. 1. The engagement surface 11 may, of course be formed as an element separate from the reinforcing rib 10a.

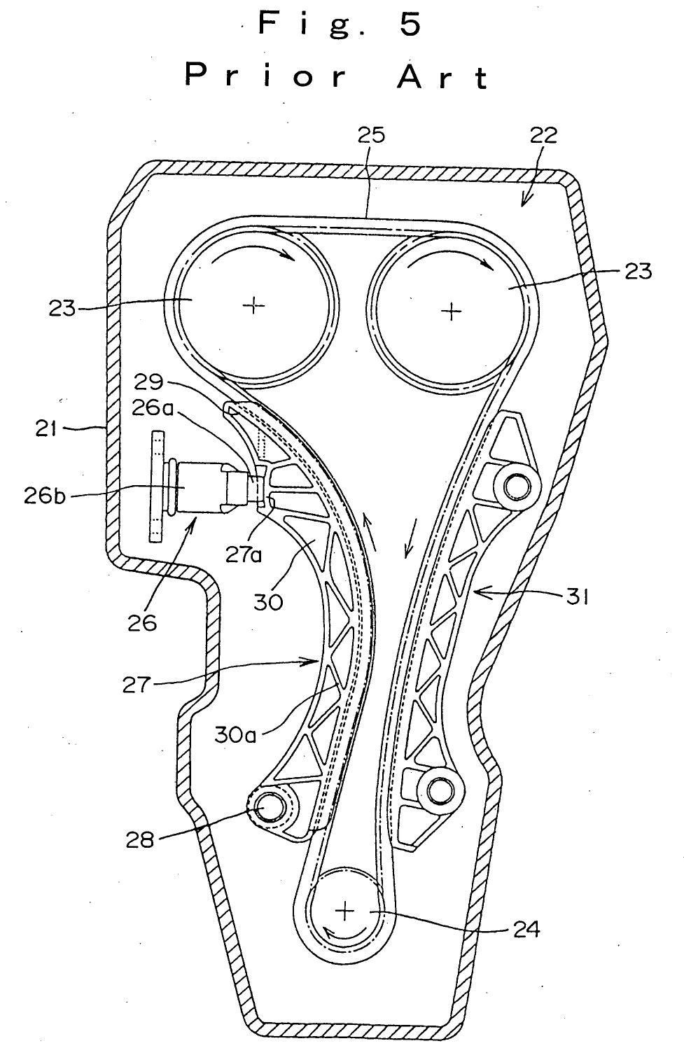

As shown in FIG. 4, a timing transmission cover 13 is mounted on the timing transmission case 1 by a set of bolts 13b, which are threaded into mounting holes la (FIG. 1) in the case 1. At least the upper mounting bolts, that is, the bolts near the camshaft sprockets, are relatively long so that the upper edge of the cover 13 can be separated from the case on the engine block by a distance sufficient to provide access to the chain and the movable guide without complete disengagement of the upper mounting bolts from the holes la. The intermediate mounting bolts and the lower mounting bolts will ordinarily be identical to the upper mounting bolts, but can be shorter because, in the timing chain replacement process, the upper part of the timing transmission cover is separated from the engine block by a greater distance than the distance by which the lower part of the cover is separated from the engine block. Thus, the upper bolts are loosened more than the intermediate bolts, and the intermediate bolts are loosened more than the lowermost bolts. In practice, a larger number of bolts and bolt holes may be provided, and the bolts are progressively loosened as required to allow the upper part of the cover to be pulled away from the engine block. The lowermost bolts are loosened only slightly, and are effective to prevent the cover from shifting laterally, i.e., in a direction parallel to the plane of movement of the transmission chain.

As shown in FIGS. 3 and 4, the timing transmission cover 13 has a hole 13a for receiving the fixing jig 14, which extends through the hole and engages engagement surface 11 (FIGS. 1 and 2). The round shaft of the fixing jig preferably fit snugly in the hole 13a, and the thickness of the cover is such that the hole 13a is sufficiently long to hold the shaft rigidly, so that it firmly holds the movable guide in a tension releasing position, as shown in FIG. 1.

As shown in FIG. 1, when the tensioner ratchet is released, and the movable guide 7 is pushed away from the chain to the maximum extent permitted by the tensioner 6, the engagement surface 11 moves just past the hole 13a, and is in a position such that it can immediately engage the fixing jig, when the guide is released following insertion of the jig. The normal position of the guide and the chain are depicted in broken lines in FIG. 1, where the chain position is indicated by reference number 5′, and the guide is shown in solid lines in its tension-releasing position, in which it is held by the fixing jig 14.

The chain can be removed and replaced while the guide is firmly held in the tension-releasing position. It is unnecessary to maintain a force on the guide manually, since the partially opened timing transmission cover and the fixing jig can hold the guide as long as required.

The through hole 13a can be normally closed by a suitable plug (not shown), which can be removed for insertion of the fixing jig when timing chain replacement is to be carried out.

Various modifications can be made to the assembly described. For example, the engagement surface on the movable guide can have any of various shapes, and the engagement surface can even be a part of a hole extending through the guide. The invention is, of course, applicable to a single overhead cam engine as well as to a dual overhead cam engine, as shown.

1. In an internal combustion engine having an engine block, a timing transmission assembly comprising:
a crankshaft sprocket;
at least one camshaft sprocket;
an endless, flexible, traveling transmission medium, arranged to travel in a plane of movement, and engaged with said sprockets for transmitting rotation from the crankshaft sprocket to said at least one camshaft sprocket;
a movable guide arranged to apply tension to a part of said medium movable from the crankshaft sprocket toward said at least one camshaft sprocket, the guide being movable toward and away from said medium, and the guide having an engagement surface facing said medium; and
a tensioner urging the guide against the transmission medium in order to apply tension to said medium; the internal combustion engine also having:
a timing transmission cover for cooperating with the engine block to form an enclosed compartment containing the sprockets, the transmission medium, the movable guide, and the tensioner, the timing transmission cover having an edge; and
fastening means for attaching the timing transmission cover to the engine block, said fastening means being loosenable to allow the timing transmission cover to be separated from the engine block sufficiently to allow access to the transmission medium through a space between the engine block and said edge of the timing transmission cover;
wherein the timing transmission cover has a through hole positioned so that a fixing jig extending through the hole can engage the engagement surface of the guide when the guide is moved to a tension-releasing position allowing the transmission medium to be removed from the sprockets, and thereby hold the guide in said tension-releasing position, whereby the transmission medium can be removed from the sprockets while the timing transmission cover is separated from the engine block by only a short distance, without the need for insertion of a tool between said edge of the cover and the engine block to hold the movable guide in said tension-releasing position.

2. A timing transmission assembly according to claim 1, in which the endless, flexible, traveling transmission medium is a silent chain.

3. A timing transmission assembly according to claim 1, in which the endless, flexible, traveling transmission medium is a roller chain.

4. A timing transmission assembly according to claim 1, in which the tensioner comprises a housing affixed to the engine block and a plunger protruding from the housing, the plunger engaging the movable guide and urging the guide against the transmission medium in a direction to apply tension to said medium.

5. A timing transmission according to claim 1, in which the movable guide is pivoted on a pivot shaft connected to the engine block, and in which said engagement surface is spaced from the pivot shaft.

6. A timing transmission assembly according to claim 1, in which the length of said fastening means is sufficient to allow the timing transmission cover to be separated from the engine block to allow access to the movable guide and the transmission medium through a space between said edge of the cover and the engine block without the fastening means being disconnected from the engine block.

7. A timing transmission assembly according to claim 1, in which said fastening means includes at least two fasteners that, when loosened, allow the timing transmission cover to be separated from the engine block sufficiently to allow access to the guide and the transmission medium through a space between the engine block and said edge of the timing transmission cover, while substantially preventing movement of the timing transmission cover in directions parallel to the plane of movement of the traveling transmission medium.

8. A timing transmission assembly according to claim 1, including a fixing jig insertable through said through hole in the timing transmission cover, in which said fastening means, when loosened sufficiently to allow access to the guide and the transmission medium through a space between the engine block and said edge of the timing transmission cover, can substantially prevent movement of the timing transmission cover in directions parallel to the plane of movement of the traveling transmission medium, and in which said through hole in the timing transmission cover is sufficiently long and narrow to hold the fixing jig in a fixed position when the fixing jig is engaged with said engagement surface of the movable guide, and the movable guide is in said tension-releasing position.

9. In an internal combustion engine having an engine block, a timing transmission assembly comprising:
a crankshaft sprocket;
at least one camshaft sprocket;
an endless timing chain, arranged to travel in a plane, and engaged with said sprockets for transmitting rotation from the crankshaft sprocket to said at least one camshaft sprocket;
a movable chain guide arranged to apply tension to a part of the chain movable from the crankshaft sprocket toward said at least one camshaft sprocket, the guide being movable toward and away from the chain, and the chain guide having an engagement surface facing the chain; and
a tensioner urging the guide against the chain in order to apply tension to the chain; the internal combustion engine also having:
a timing chain cover for cooperating with the engine block to form an enclosed compartment containing the sprockets, the timing chain, the movable chain guide, and the tensioner, the timing chain cover having an edge; and
fastening means for attaching the timing chain cover to the engine block, said fastening means being loosenable to allow the timing chain cover to be separated from the engine block sufficiently to allow access to the timing chain through a space between the engine block and said edge of the timing chain 1 cover;
wherein the timing chain cover has a through hole positioned so that a fixing jig extending through the hole can engage the engagement surface of the guide when the guide is moved to a chain-tension-releasing position allowing the chain to be removed from the sprockets, and thereby hold the guide in said chain-tension-releasing position, whereby the chain can be removed from the sprockets while the timing chain cover is separated from the engine block by only a short distance, without the need for insertion of a tool between said edge of the cover and the engine block to hold the movable guide in the tension-releasing position.

10. A method for removing a timing chain from the timing transmission of an internal combustion engine, wherein said chain connects a crankshaft sprocket in driving relationship to at least one camshaft sprocket, and travels in a planar path of movement, tension is maintained in the chain by a movable guide urged into sliding contact with the chain by a tensioner, and the sprockets, the chain, the guide and the tensioner are housed within a compartment defined by an engine block and a timing transmission cover connected to the engine block by loosenable fastening means, the method comprising:
loosening the fastening means sufficiently to provide access, through a space between the engine block and an edge of the cover, to the chain, but not enough to allow the timing chain cover to shift parallel to the plane of travel of the chain;
pushing the movable guide in a direction to allow slack in the chain;
inserting a fixing jig through a hole in the timing transmission cover, and engaging the movable guide with the fixing jig while the guide is positioned to allow slack in the chain, thereby temporarily preventing movement of the guide toward the chain;
and
removing the chain from the sprockets.

11. The method according to claim 10, in which in the step of loosening the fastening means, the fastening means are loosened sufficiently to allow access to the movable guide through the space between the engine block and an edge of the cover, and in which, for the step of pushing the movable guide, access to the guide is obtained through said space.
